(19) United States
(12) Patent Application Publication
(10) Pub. No.: US 2005/0003277 A1
(43) Pub. Date: Jan. 6, 2005

(54) Negative electrode for lithium secondary battery, method of preparing same, and lithium secondary battery comprising same

(75) Inventors: Jea-Woan Lee, Yongin-city (KR); Jong-Ki Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung SDI Co., Ltd., Suwon-si (KR)

(21) Appl. No.: 10/842,428

(22) Filed: May 11, 2004

(30) Foreign Application Priority Data
Jul. 1, 2003 (KR) 2003-44403

(51) Int. Cl. H01M 10/36; H01M 10/40; H01M 2/16; B05D 5/12

(52) U.S. Cl. 429/322; 429/317; 427/126.1; 429/246

(57) ABSTRACT

A negative electrode of a lithium secondary battery, a method of fabricating the same, and a lithium secondary battery including the same utilize, in the negative electrode, a negative active material layer and a lithium ion conductive layer formed on the negative active material layer, wherein the lithium ion conductive layer includes a compound represented by the following Formula 1:
LiₓCO_{y} (1) wherein 1<x<3, and 2<y<4.

### CROSS-REFERENCE TO RELATED APPLICATIONS

This application is based on application No. 2003-44403 filed in the Korean Intellectual Property Office on Jul. 1, 2003, the disclosure of which is incorporated hereinto by reference.

### BACKGROUND OF THE INVENTION

1. Field of the Invention

The present invention relates to a negative electrode for a lithium secondary battery, a method of preparing the same, and a lithium secondary battery comprising the same, and more particularly, to a negative electrode for a lithium secondary battery having improved cycle-life characteristics, a method of preparing the same, and a lithium secondary battery comprising the same.

2. Description of the Related Art

With an increase in the use of portable electronic equipment, the demand for a battery which is lighter in weight and has a higher capacity has also increased. A lithium metal secondary battery in which lithium metals are used as a negative active material is a strong candidate for satisfying the demand, since it is expected to have a high capacity. Among the candidates, a lithium-sulfur battery in which the sulfur-based material is used as a positive active material is most attractive.

The lithium-sulfur batteries are secondary batteries composed of a positive active material of a sulfur-based compound having sulfur-sulfur bonds as a positive active material, and a negative active material such as an alkaline metal or lithium metal that reversibly intercalates metal ions. The batteries produce and store electrical energy as a result of a redox reaction in which the oxidation number of sulfur is decreased and sulfur-sulfur bonds are cleaved upon the reduction reaction (discharge), and the oxidation number of sulfur is increased and sulfur-sulfur bonds are regenerated upon the oxidation reaction (charge).

Lithium metal is widely utilized as a negative active material since it is light in weight and has a high energy density. However, the lithium metal may cause problems in that the cycle life characteristics of the battery are deteriorated due to a high reactivity of the lithium metal. A protective layer has been suggested to protect the surface of the lithium metal.

The protective layer may be exemplified by an inorganic protective layer and a polymer protective layer. With respect to the protective layers, a lithium ion conductive material of LIPON (Lithium Phosphorus Oxy-Nitride) has been actively researched. The LIPON protective layer is formed by a sputtering process under a nitrogen gas atmosphere. When it is desirable to form a lithium layer directly on the surface of the lithium metal, the lithium metal may react with the nitrogen gas, thus generating an adduct of a black porous lithium composite compound which has a poor binding strength to the surface of the lithium metal.

Further, when the protective layer is composed of the polymer, the lithium metal may react with the organic solvent used to form the protective layer.

To avoid the above problems, U.S. Patent Laid-open Publication No. 2002/0012846 A1 (MOLTECH CORPORATION, USA) discloses a temporary protective layer to protect the surface of the lithium metal during preparation of a protective layer on the surface of the lithium metal. The temporary protective layer comprises a material generated from a reaction of the lithium and a gaseous material such as the gas used in a plasma CO₂ treatment, or a material that readily alloys with the lithium, for example, copper. However, the temporary protective layer generated from the reaction with the CO₂ gas is too thin (less than 20 Å) to provide adequate protection to the surface of the lithium. Alternatively, the temporary protective layer formed from the metal that may alloy with the lithium metal causes a huge volume variation, rendering the structure unstable.

### SUMMARY OF THE INVENTION

It is an aspect of the present invention to prevent generation of an adduct of a black porous lithium composite compound which has an ineffective binding strength to the surface of the lithium when a protective layer such as LIPON is formed under a nitrogen gas atmosphere, and to provide a negative electrode of a lithium secondary battery, including a pretreatment layer to prevent a direct contact between the lithium and a solvent used to form a polymer protective layer.

It is another aspect of the present invention to provide a method of preparing a negative electrode of a lithium secondary battery wherein the negative electrode includes a pretreatment layer prepared by using a simple process.

It is still another aspect of the present invention to provide a lithium secondary battery including the negative electrode.

To accomplish the above and/or other aspects, the present invention provides a negative electrode of a lithium secondary battery, including a negative active material layer and a lithium ion conductive layer formed on the negative active material layer, wherein the lithium ion conductive layer includes a compound represented by the following Formula 1:
LiₓCO_{y} (1)
wherein 1<x<3, and 2<y<4.

The present invention further provides a method of preparing a negative electrode of a lithium secondary battery, wherein the method includes depositing a lithium ion conductive material on a negative active material layer under an inert gas atmosphere to provide a lithium ion conductive layer formed on the negative active material layer, and wherein the lithium ion conductive layer includes a compound represented by the Formula 1.

In addition, the present invention still further provides a lithium secondary battery that utilizes a negative electrode that includes a negative active material layer and a lithium ion conductive material layer formed on the negative active material, wherein the lithium ion conductive layer includes a compound represented by the Formula 1; a positive electrode that includes a positive active material selected from the group consisting of elemental sulfur (S₈), a sulfur-based compound, and a mixture thereof; and an electrolyte.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing an embodiment of a structure of the lithium secondary battery of the present invention;

FIG. 2 is a graph showing cyclic-life characteristics of lithium-sulfur cells of Examples 1-3, Reference Example 1, and Comparative Example 1;

FIG. 3 is a SEM micrograph of the electrode of Example 1 after it was immersed in a dimethoxy ethane solution for 5 minutes and then taken therefrom; and

FIG. 4 is a SEM micrograph of the electrode of Comparative Example 2 after it was immersed in a dimethoxy ethane solution for 5 minutes and then taken therefrom.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Generally, lithium metal is known to be used to provide a negative active material for a lithium metal battery, and particularly, for a lithium-sulfur battery due to its properties such as its light weight and high energy density. Nonetheless, lithium metal has the disadvantage of having an excessively high reactivity. To solve the problems caused by the high reactivity, studies to provide a protective layer of the lithium metal are being actively pursued. Although a polymer organic protective layer has generally been suggested for such a protective layer, it also causes problems in that the lithium metal may react with the organic solvent used to provide the protection layer.

During research to find a temporary protection layer to prevent contact between the lithium metal and the organic solvent used to form a protective layer, the present inventors found that contact between the negative active material layer and the organic solvent of the protective layer may be prevented and that the cycle-life may be improved by forming the compound represented by Formula 1 between the negative active material and the organic protective layer by the sputtering technique, as set forth below in the present invention:
Liₓ CO_{y} (1)
wherein 1<x<3, and 2<y<4.

The compound of Formula 1 is a lithium ion conductive material. The lithium ion conductive layer obtained from the compound should have an ion conductivity greater than or equal to 1×10⁻¹²S/cm. A thicker layer may be provided depending upon the higher ion conductivity, and thus, a desirable pretreatment layer is provided. Generally, ion conductivity of 1×10⁻¹²S/cm has been considered to exert an unfavorable influence on battery performance, but the lithium ion conductive layer formed by depositing, typically sputtering, the compound represented by the Formula 1 according to the present invention may improve the cycle-life characteristics of the battery. However, the improvement of the cycle-life characteristics is not exhibited when the layer is formed by a gas depositing process instead of a sputtering process.

The effect on the cycle-life characteristics is attributed to uniformly generated cracks on the lithium ion conductive layer during the charge and the discharge intervals, and thus it facilitates uniform movement of the lithium ions on the surface of the lithium and inhibits development of dendrites or generating dead lithium in which the lithium is concentrated on the inside. Further, the layer may directly prevent contact between the negative active layer and the organic solvent so that the lithium loss due to the reaction with the organic solvent is prevented.

Since the conventional inorganic protective layer of LIPON, which is utilized to prevent contact between the negative active material layer and the organic solvent for forming an organic protective layer, imparts an unfavorable influence on the cycle-life characteristics when it is used alone, the organic protective layer is required for the negative electrode. However, according to the present invention, the lithium ion conductive layer does not require an additional organic protective layer to provide a negative electrode. Nevertheless, where desired, the negative electrode of the present invention may further include the organic protective layer.

When the ion conductivity of the lithium ion conductive layer is less than 1×10⁻¹²S/cm, the lithium ions are not readily transmitted.

The lithium ion conductive layer typically has a thickness of 20 to 300 Å. When the thickness is less than 20 Å, contact between the negative active material layer and the organic solvent is difficult to prevent completely, while when the thickness is more than 300 Å, the ion conductivity of the lithium ion conductive layer is lowered so that an overvoltage is applied to prevent impairment of the battery performance.

The negative electrode may further include a protective layer on the lithium ion conductive layer. The protective layer may comprise the organic material or the polymer. The organic material may include, but is not limited to, lithium silicate, lithium borate, lithium aluminate, lithium phosphate, lithium phosphorus oxynitrate, lithium silicosulfide, lithium germanous sulfide, lithium lanthanum oxide, lithium tantalum oxide, lithium niobium oxide, lithium titanium oxide, lithium borosulfide, lithium aluminosulfide, lithium phosphorosulfide, and a mixture thereof. The polymer may include, but is not limited to, a polymer polymerized with at least one acrylate monomer selected from the group consisting of alkyl acrylate, glycol acrylate, and polyglycol acrylate.

According to the present invention, the negative active material layer may comprise a negative active material of a lithium metal or a lithium alloy. The lithium alloy may include, but is not limited to, a lithium tin alloy, and any conventional lithium alloy that may act as a negative active material in the lithium-sulfur battery.

The negative electrode of the present invention is prepared by depositing the compound represented by the following Formula 1 under an inert atmosphere using the target to provide a lithium ion conductive layer formed on the negative active material layer:
LiₓCO_{y} (1)
wherein 1<x<3, and 2<y<4.

The target may include a lithium ion conductive material which is the same as the compound represented by the Formula 1.

The inert atmosphere may include, without limitation, any conventional gas atmosphere used for the sputtering process, as long as the gas does not participate in the reaction, for example, an argon gas atmosphere may be utilized.

The deposition process is typically a sputtering process. The sputtering process may be carried out for a sufficient time to provide a lithium ion conductive layer in a thickness of 20 to 300 Å on the negative active material layer. The sputtering process time depends upon the sputtering system, that is, depending upon the equipment scale, the target size, the power to be applied, and the like, but the sputtering process is generally continued for about 10 minutes to 5 hours, until the desirable thickness of the lithium ion conductive layer is obtained on the negative active material layer.

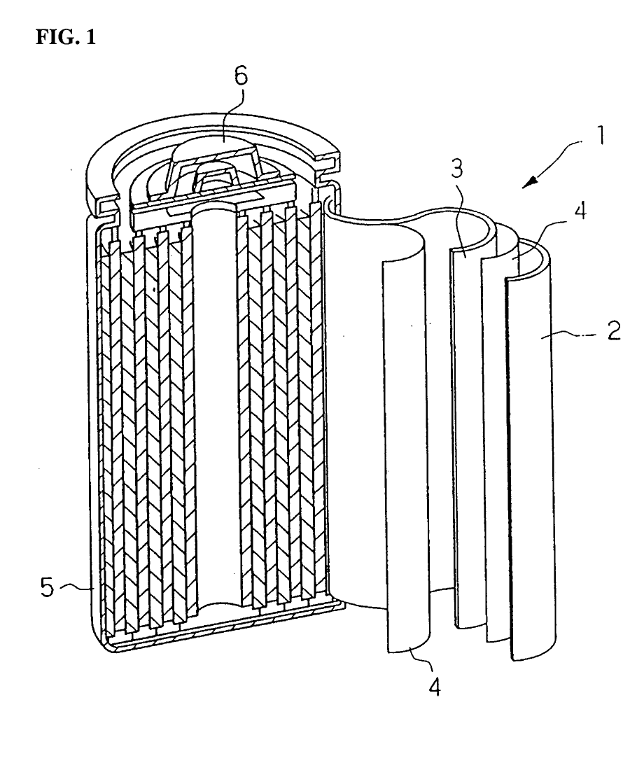

One embodiment of the lithium secondary battery, including the negative electrode of the present invention, is shown in FIG. 1. The battery includes a positive electrode 3, a negative electrode 2, a separator 4 interposed between the positive electrode 3 and the negative electrode 2, and an electrolyte between the positive electrode 3 and the negative electrode 2. The battery further includes a battery case 5 and a sealing portion 6 sealing the battery case 5. The configuration of the rechargeable lithium battery is not limited to the structure shown in FIG. 1, as it can be readily modified into a prismatic, cylindrical, or pouch type battery as is well understood in the related art.

The positive electrode includes any positive active material of elemental sulfur (S₈), a sulfur based compound, or a mixture thereof. The sulfur-based compound includes at least one compound selected from the group consisting of Li₂Sₙ (n≧1), an organic sulfur compound, and a carbon-sulfur polymer ((C₂Sₓ)ₙ: x=2.5˜50, n≧2). However, it may include any conventional positive active materials used for a lithium secondary battery, for example, a lithium transit metal oxide.

The lithium secondary battery of the present invention includes an electrolyte, and the electrolyte includes an organic solvent and an electrolyte salt.

The organic solvent may be a single solvent or a mixture of two or more organic solvents. If the organic solvent is a mixture of two or more organic solvents, it is preferable to select at least one solvent from at least two groups of a weak polar solvent group, a strong polar solvent group, and a lithium metal protection solvent group.

The term “weak polar solvent,” as used herein, refers to a solvent that may dissolve elemental sulfur, and has a dielectric coefficient of less than 15. The weak polar solvent may include aryl compounds, bicyclic ether, and acyclic carbonate compounds. The term “strong polar solvent,” as used herein, refers to a solvent that may dissolve lithium polysulfide, and has a dielectric coefficient of more than 15. The strong polar solvent may include bicyclic carbonate compounds, sulfoxide compounds, lactone compounds, ketone compounds, ester compounds, sulfate compounds, or sulfite compounds.

The term “lithium protection solvent,” as used herein, refers to a solvent which forms an effective protective layer, i.e., a stable solid-electrolyte interface (SEI) layer on the lithium surface, and shows an effective cyclic efficiency greater than or equal to 50%. The lithium protection solvent is selected from saturated ether compounds, unsaturated ether compounds, or heterocyclic compounds including N, O, and S, and a composite thereof.

Examples of the weak polar solvents include xylene, dimethoxyethane, 2-methyltetrahydrofurane, diethyl carbonate, dimethyl carbonate, toluene, dimethyl ether, diethyl ether, diglyme, and tetraglyme.

Examples of the strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, and ethylene glycol sulfite.

Examples of the lithium protection solvents include tetrahydrofuran, ethylene oxide, dioxolane, 3,5-dimethylisoxazole, 2,5-dimethyl furan, furan, 2-methyl furan, 1,4-oxane, and 4-methyldioxolane.

The electrolyte salt may include at least one lithium salt selected from lithium fluoro methane sulfonimide or lithium triplate. The lithium salt may be added in a concentration of between 0.6 and 2.0 M, preferably between 0.7 and 1.6 M. When the concentration of the lithium salt is less than 0.6 M, the conductivity of the electrolyte is too low to maintain the electrolyte performance, while when it is more than 2.0 M, the viscosity of the electrolyte is too high to facilitate moving the lithium ions.

Hereinafter, the present invention will be explained in detail with reference to examples. These examples, however, should not in any sense be interpreted as limiting the scope of the present invention.

### COMPARATIVE EXAMPLE 1

Cu was thermally deposited on a clear, cleaned glass to about 3000 Å. To the obtained glass/copper substrate, lithium was thermally deposited to 20 μm to provide a negative electrode.

75% by weight of an elemental sulfur (S₈) active material, 12% by weight of a polyethylene oxide binder, and 13% by weight of a carbon black conductive agent were mixed to provide a positive electrode.

Using the lithium negative electrode, the positive electrode, an electrolyte, and a separator, the lithium-sulfur cell was fabricated. The separator was prepared as a three-layered film with a thickness of 16 μm from polypropylene/polyethylene/polypropylene. The electrolyte was dimethoxy ethane/diglyme/dioxolane (4:4:2 in volume ratio) in which 1M LiN(SO₂CF₃)₂ was dissolved.

### COMPARATIVE EXAMPLE 2

Cu was thermally deposited to about 3000 Å as in Comparative Example 1, on a clear, cleaned glass. Lithium was thermally deposited to 20 μm on the obtained glass/Cu substrate.

Subsequently, the glass/Cu substrate was treated with plasma CO₂ to form a 10 Å thick Li₂CO₃ layer on the lithium-deposited substrate to provide a negative electrode having the glass/Cu/lithium/Li₂CO₃ layers. The thickness was measured according to AFM (atomic force microscopy).

A lithium-sulfur cell was fabricated using the negative electrode by the same procedure as in Comparative Example 1.

### EXAMPLE 1

Cu was thermally deposited to about 3000 Å as in Comparative Example 1 on a clear, cleaned glass. Lithium was thermally deposited to 20 μm on the obtained glass/Cu substrate.

Subsequently, the glass/Cu substrate was subjected to the RF supporting process using a 2 inch, 99.9% purity Li₂CO₃ target to form a 96 Å thick Li₂CO₃ layer on the lithium-deposited substrate to provide a negative electrode having the glass/Cu/lithium/Li₂CO₃ layers. The thickness was measured according to AFM (atomic force microscopy).

A lithium-sulfur cell was fabricated using the negative electrode by the same procedure as in Comparative Example 1.

### EXAMPLE 2

A lithium-sulfur cell was fabricated by the same procedure as in Example 1, except that a Li₂CO₃ layer was formed to a thickness of 30 Å.

### EXAMPLE 3

A lithium-sulfur cell was fabricated by the same procedure as in Example 1, except that a Li₂CO₃ layer was formed to a thickness of 300 Å.

### REFERENCE EXAMPLE 1

A lithium-sulfur cell was fabricated by the same procedure as in Example 1, except that a Li₂CO₃ layer was formed to a thickness of 400 Å.

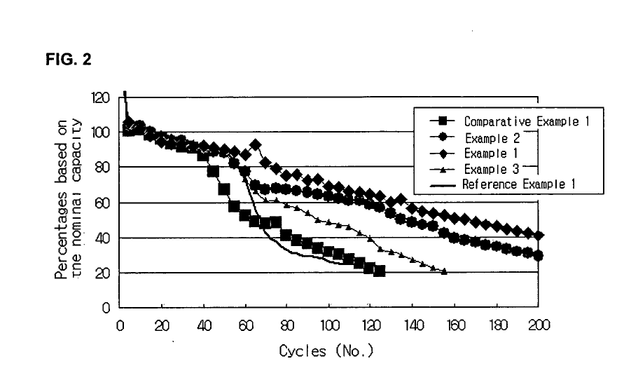

Cells obtained from Examples 1 to 3, Reference Example 1, and Comparative Example 1 were discharged at 0.5 C and 1.5 V and let stand for 5 minutes, then charged at 0.2 C and 2.8 V to determine the cycle-life characteristics, over 60 cycles, and the results are shown in FIG. 2. As shown in FIG. 2, it was demonstrated that the cell of Example 1 having the Li₂CO₃ layer had more improved cycle-life characteristics than those of the cell of Comparative Example 1 having no Li₂CO₃. In addition, the cell of Reference Example 1 with a Li₂CO₃ layer thickness of more than 300 Å was demonstrated to have remarkably deteriorated cycle-life characteristics over the 60 cycles. It was estimated that since the Li₂CO₃ layer itself has poor ion conductivity of 1×10⁻¹², it cannot facilitate moving the lithium ions.

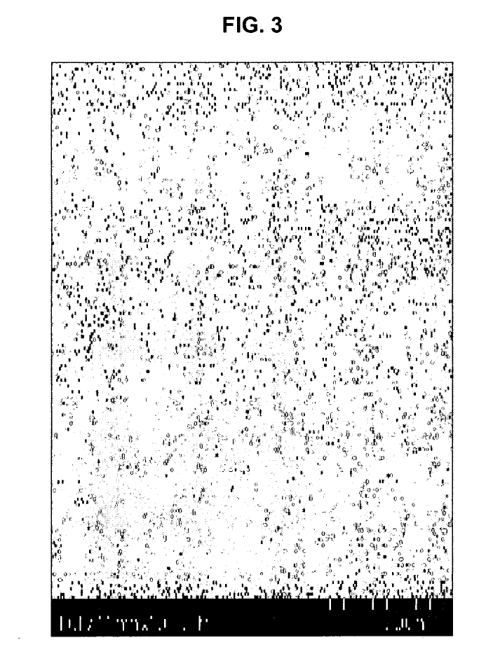

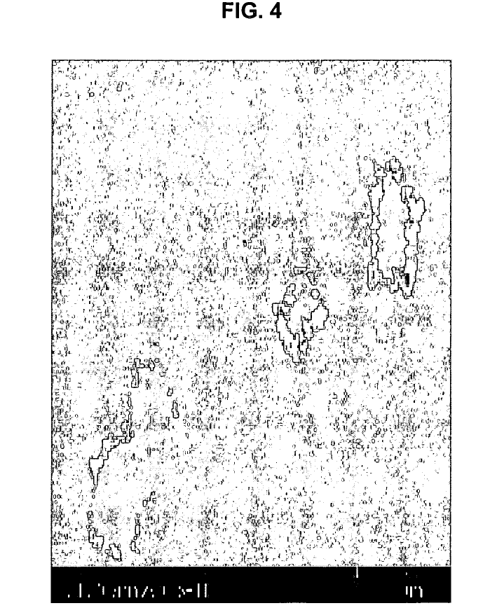

FIGS. 3 and 4 respectively show SEM (Scanning Electron Microscopy) micrographs in which the electrodes of Example 1 and Comparative Example 2 were immersed in dimethoxy ethane solvent for 5 minutes and then taken out. As shown in FIGS. 3 and 4, a thick Li₂CO₃ layer of Example 1 formed by sputtering imparts an effective protective layer to block the solvent, while a thin Li₂CO₃ layer of Comparative Example 2 formed by the gas reaction does not block the solvent.

As described in the above, the negative electrode for a lithium secondary battery of the present invention has a lithium ion conductive layer with an optimal thickness, so that it prevents the reaction between the negative active material and the electrolyte, and cycle-life characteristics are improved.

Although a few embodiments of the present invention have been shown and described, it would be appreciated by those skilled in the art that changes may be made in these embodiments without departing from the principles and spirit of the invention, the scope of which is defined in the claims and their equivalents.

1. A negative electrode of a lithium secondary battery, comprising:
a negative active layer; and
a lithium ion conductive layer formed on the negative active material,
wherein the lithium ion conductive layer comprises a compound represented by the following Formula 1:
LiₓCO_{y} (1)
wherein 1<x<3, and 2<y<4.

2. The negative electrode of a lithium secondary battery according to claim 1, wherein the lithium ion conductive layer has a thickness that is between 20 and 300 Å.

3. The negative electrode of a lithium secondary battery according to claim 1, wherein the lithium ion conductive layer has an ion conductivity that is at least 1×10⁻¹²S/cm.

4. The negative electrode of a lithium secondary battery according to claim 1, wherein the negative electrode further comprises a protective layer formed on the lithium ion conductive layer.

5. The negative electrode of a lithium secondary battery according to claim 4, wherein the protective layer comprises a compound selected from the group consisting of lithium silicate, lithium borate, lithium aluminate, lithium phosphate, lithium phosphorus oxynitrate, lithium silicosulfide, lithium germanous sulfide, lithium lanthanum oxide, lithium tantalum oxide, lithium niobium oxide, lithium titanium oxide, lithium borosulfide, lithium aluminosulfide, lithium phosphorosulfide, and a mixture thereof.

6. The negative electrode of a lithium secondary battery according to claim 5, wherein the protective layer comprises a polymer having at least one acrylate monomer selected from the group consisting of alkyl acrylate, glycol acrylate, and polyglycol acrylate.

7. The negative electrode of a lithium secondary battery according to claim 1, wherein the negative electrode of the lithium secondary battery is the negative electrode of a lithium-sulfur battery.

8. A method of preparing a negative electrode of a lithium secondary battery comprising:
depositing a lithium ion conductive material on a negative active material layer under an inert gas atmosphere to provide a lithium ion conductive layer formed on the negative active material layer,
wherein the lithium ion conductive layer comprises a compound represented by the following Formula 1:
LiₓCO_{y} (1)
wherein 1<x<3, and 2<y<4.

9. The method of preparing a negative electrode of a lithium secondary battery according to claim 8, wherein the lithium ion conductive layer has an ion conductivity greater than or equal to 1×10¹² S/cm.

10. The method of preparing a negative electrode of a lithium secondary battery according to claim 8, wherein the deposition is carried out by a sputtering process.

11. The method of fabricating a negative electrode of a lithium secondary battery according to claim 8, further comprising depositing a protective layer material on the lithium ion conductive layer to provide a protective layer formed on the lithium ion conductive layer.

12. The method of preparing a negative electrode of a lithium secondary battery according to claim 11, wherein the protective layer comprises a compound selected from the group consisting of lithium silicate, lithium borate, lithium aluminate, lithium phosphate, lithium phosphorus oxynitrate, lithium silicosulfide, lithium germanous sulfide, lithium lanthanum oxide, lithium tantalum oxide, lithium niobium oxide, lithium titanium oxide, lithium borosulfide, lithium aluminosulfide, lithium phosphorosulfide, and a mixture thereof.

13. The method of preparing a negative electrode of a lithium secondary battery according to claim 12, wherein the protective layer comprises a polymer having at least one acrylate monomer selected from the group consisting of alkyl acrylate, glycol acrylate, and polyglycol acrylate.

14. A lithium secondary battery comprising:
a negative electrode comprising:
a negative active material layer; and
a lithium ion conductive layer formed on the negative active material layer, wherein the lithium ion conductive layer comprises a compound represented by the following Formula 1:
LiₓCO_{y} (1)
wherein 1<x<3, and 2<y<4;
a positive electrode comprising:
a positive active material selected from the group consisting of elemental sulfur (S₈), sulfur based compound, a mixture thereof; and
an electrolyte.

15. The lithium secondary battery according to claim 14, wherein the lithium ion conductive layer has a thickness of between 20 and 300 Å.

16. The lithium secondary battery according to claim 14, wherein the lithium ion conductive layer has an ion conductivity greater than or equal to 1×10⁻¹² S/cm.

17. The lithium secondary battery according to claim 14, wherein the negative electrode further comprises a protective layer formed on the lithium ion conductive layer.

18. The lithium secondary battery according to claim 17 wherein the protective layer comprises a compound selected from the group consisting of lithium silicate, lithium borate, lithium aluminate, lithium phosphate, lithium phosphorus oxynitrate, lithium silicosulfide, lithium germanous sulfide, lithium lanthanum oxide, lithium tantalum oxide, lithium niobium oxide, lithium titanium oxide, lithium borosulfide, lithium aluminosulfide, lithium phosphorosulfide, and a mixture thereof.

19. The lithium secondary battery according to claim 18, wherein the protective layer comprises a polymer having at least one acrylate monomer selected from the group consisting of alkyl acrylate, glycol acrylate, and polyglycol acrylate.

20. The lithium secondary battery according to claim 14, wherein the lithium secondary battery is a lithium-sulfur battery.
